(19) United States
(12) Patent Application Publication
(10) Pub. No.: US 2025/0198289 A1
(43) Pub. Date: Jun. 19, 2025

(54) TAILINGS DUST SUPPRESSION

(71) Applicants: Arizona Board of Regents on Behalf of the University of Arizona, Tucson, AZ (US); Auxilium Technology Group LLC, Tucson, AZ (US)

(72) Inventors: Dominic Gervasio, Tucson, AZ (US); Minkyu Kim, Tucson, AZ (US); Abraham F. Jalbout, Tucson, AZ (US)

(21) Appl. No.: 18/846,258

(22) PCT Filed: Mar. 13, 2023
(86) PCT No.: PCT/US23/15141

§ 371 Date: Sep. 12, 2024

Related U.S. Application Data
(60) Provisional application No. 63/319,077, filed on Mar. 11, 2022.

(51) Int. Cl. E21F 5/06; C09K 3/22

(52) U.S. Cl. CPC E21F 5/06; C09K 3/22

(57) ABSTRACT

This present disclosure is directed to a method of treating mining tailings from mining operations using dust suppression composition disclosed herein.

### CROSS REFERENCE TO RELATED APPLICATIONS

This application claims priority to U.S. application Ser. No. 63/319,077, filed on Mar. 11, 2022, the contents of which is hereby incorporated by reference in its entirety.

### FIELD OF THE INVENTION

The field of the invention relates generally to suppression of dust from tailings of mining operations.

### BACKGROUND

Tailings are the ore waste of mining companies and are fine particles. They are typically placed in large piles or pools for storage and, where possible, eventually reused or reclaimed. However, when tailings sit in a dry, untreated state, many of the smallest particles can be blown away by the wind. The dust that is generated from these tailings can be an environmental hazard if heavy metal containing dust contaminate water sources.

Additionally, the generation of dust during transport and handling of tailing materials has long been recognized as an economic loss and a health hazard. To prevent tailing dust erosion, fluids are typically sprayed over the surface of the tailing storage pile that provides a protective, erosion-resistant barrier against the wind.

Traditionally, there are four ways to prevent dust generation using a chemical solution. Two are temporary: using foam to form a physical blanket over the material, usually when it is on a conveyor belt, or using surfactants in water to wet the dusting material and prevent dust generation through multiple handling points. These remedies last only as long as the foam remains intact or the material remains wet. The second two approaches focus on longer-term dust control. They involve applying a chemical binder to the surface of a stockpile or railcar to form a crust, preventing wind-born loss, or to treat the entire mass of material with a binder, cementing the smaller dust particles to larger particles on a semi-permanent basis. The former approach, depending on the choice of binder, can form a crust lasting over a year. The latter, depending on the choice of binder, can render a dusting material effectively non-dusting for a time ranging from days to months.

Existing solutions are made of expensive synthetic materials. There is an urgent need to for a method to reducing or eliminating dust that is associated with tailings while minimizing clogging and impediment of metal recovery.

The inventors developed a dust suppression technology made of inexpensive materials that can break down on its own once the tailing pile is removed.

### DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

The term “water glass” refers to silicate is SiO₃⁻² which is a water-soluble form of silica usually in the sodium silicate form, Na₂SiO₃. In some embodiments, water glass may be provided in the form of sodium silicate or potassium silicate.

The SI unit of measurement for shear rate is s−1, expressed as “reciprocal seconds” or “inverse seconds”.

The term “Pechini reagent” as used herein refers to a polyester polymer blend, which may be made e.g., by heating a glycol (e.g., ethylene glycol) to e.g., a temperature of about 60° C., then adding an alpha-hydroxycarboxylic acid (e.g., citric acid) with stirring (e.g., constant stirring) until a homogenous mixture is obtained. The term “Pechini reagent” also includes an aqueous solution of oxides, like silica oxide, mixed with an alpha-hydroxycarboxylic acid (e.g., citric acid). An Pechini reagent based on oxides may be prepared by mixing metal oxides (e.g., silica, silicate, or alumino silicate) with an alpha-hydroxycarboxylic acid (e.g., citric acid) and a glycol (e.g., ethylene glycol). The condensation of glycol and carboxylic acid forms a polymer at a high temperature (e.g., around 100 degrees C.), but polymer can also form at even at lower temperatures including temperatures as low as room temperature.

The term “sprayable composition” as used herein refers to a dust suppressing composition as disclosed herein, where the viscosity of said composition is below 100 cps at shear rates up to 1,000 s−1.

The term “wt %” as used herein refers to the mass fraction of a substance within a mixture is the ratio (wi) of the mass (mi) of that substance to the total mass of the mixture. Expressed as the formular, the mass fraction is:

$$wi - \frac{mi}{mtot}$$

One problem that the present invention solves is reducing or eliminating dust that is associated with tailings from mining operations. Tailings are the ore waste that are generated by mining companies and this waste includes fine particles or dust which is susceptible to fires and explosions. The dust that is generated from these tailings has been a constant concern in the industry. To suppress dust, traditionally, expensive polymers such as PPO or poly(p-phenylene oxide) and PEO or polyethylene oxide are sprayed on tailing but have issues such as clogging, impeding metal recovery when water in tailings is reclaimed, and high molecular weight forms do not readily break down.

One aspect of the invention pertains to a composition comprising one or more cellulose based polymers, and one or more additives chosen from silica, silicate (water glass) and a Pechini reagent (e.g., 1 citrate salt:1 ethylene glycol), alone, or as additives, to suppress dust.

To suppress dust, traditionally, expensive polymers such as PPO or poly(p-phenylene oxide) and PEO or polyethylene oxide are sprayed on tailing. The problem with this approach is that there is a tendency clogging, impede metal recovery when water in tailings is reclaimed, and high molecular weight forms do not readily break down. What is proposed herein is using cellulose based polymers and silica, silicate (water glass) or Pechini reagent (1 citrate and 1 ethylene glycol) alone or as additives. The claimed reagents are inexpensive, environmentally benign and readily decomposed. The ability to decompose is critical when tailings are repurposed.

One advantage of the present invention is that the reagents used to formulate dust suppression compositions and concentrates are inexpensive, environmentally benign and readily decomposed under normal conditions. The ability to decompose is of particular advantage when tailings are repurposed. To suppress dust, the reagent is incorporated into an aqueous (water base) formulation which can be spray-coated on the tailings, so that the fine dust particles stick together and do not become airborne when wind blows over the tailings.

A further aspect of the invention pertains to a composition comprising about 0.1 wt. % carboxy methyl cellulose (CMC), and optionally one or more reagents chosen from silica, silicate and Pechini reagent, or a combination thereof. The additional reagents may be used either alone or as additives to said composition.

A further aspect of the invention pertains to a method of dust mitigation for mine tailings comprising contact a composition comprising CMC, SiO₂ (silica), water glass, Pechini reagent and water with said dust. In some embodiments, wherein composition is applied to the tailing by spraying (e.g., when the tailings are in storage at a mine site, when the tailings are leaving the mine, when the tailings are at an industrial site, the tailings are fresh at a mining operation, or legacy tailings at a mine).

Another aspect of the invention pertains to a method of suppressing dust from mine tailings, said method comprising contacting (e.g., spraying) the tailings with a dust suppressing composition disclosed herein.

Another aspect of the invention pertains to a dust suppressing composition comprising one or more suppressing reagents. In some embodiments, said suppressing reagents are selected from the group consisting of CMC, SiO₂ (silica), water glass, water, and Pechini reagent. In some embodiments, said dust suppressing composition comprises CMC and water, and optionally a Pechini reagent, wherein CMC is in a concentration of 0.1-30 wt %, 0.1-2 wt %, or 2-10 wt % or 10-20 wt %, or 20-30 wt % or 10-30 wt %.

A further embodiment of the invention encompasses a dust suppressing composition comprising CMC, SiO₂ (silica) and water, and optionally a Pechini reagent, wherein said CMC and said silica are in a ratio of about 1:10.

A yet further embodiment of the invention encompasses a dust suppressing composition, said composition comprising CMC, waterglass and water, and optionally a Pechini reagent, wherein CMC and waterglass are in a ratio of about 1:10.

A yet further embodiment of the invention encompasses a dust suppressing composition, said composition comprising CMC, waterglass, Pechini reagent, and water, wherein the Pechini reagent comprises an aqueous solution of oxides mixed with an alpha-hydroxycarboxylic acid such as citric acid.

A yet further embodiment of the invention encompasses a dust suppressing composition, said composition comprising a CMC, SiO₂ (silica), a Pechini reagent and water, wherein the Pechini reagent comprising aqueous solution of oxides mixed with an alpha-hydroxycarboxylic acid such as citric acid.

A yet further embodiment of the invention encompasses a dust suppressing composition, said composition comprising a 0.2-30 wt % CMC, water, and silica or water glass. In some embodiments, said composition may be stored in concentrated form and be applied as a diluted formulation. In some embodiments, said CMC is present in an amount of 0.1-30 wt %, 0.1-2 wt %, or 2-10 wt % or 10-20 wt %, or 20-30 wt % or 10-30 wt %.

A further aspect of the invention pertains to method of preparing a dust suppressing composition, said method comprising:
adding CMC and water, and optionally an inorganic reagent (such as silicate or silica), to a vessel to obtain a mixture;
stirring said mixture (using e.g., a shearing blade stirrer) for a period of time (e.g. at least 8 hours (e.g., overnight)) to obtain a CMC solution. The concentration of the CMC solution obtained is in an amount of 0.1-30 wt %, 0.1-2 wt %, or 2-10 wt % or 10-20 wt %, or 20-30 wt % or 10-30 wt %. In some embodiments, the mixture may be heated (e.g., up to about 90 deg Celsius) while stirring. In some embodiments, the mixture that is stirred overnight, or for at least 5 days.

In some embodiments, a Pechini reagent is first mixed with carboxy methyl cellulose (CMC).

A further aspect of the invention pertains to a sprayable dust suppression composition/agent, where the viscosity of said composition is below 100 cps at shear rates up to 1,000 s−1.

In some embodiments, the invention pertains to a dust suppression composition that agent can be mixed at the mill directly with slurry before being discharged to a storage facility (e.g., tailings storage facility).

### EXEMPLARY LIST OF EMBODIMENTS

1. A method of suppressing dust from mine tailings, said method comprising contacting said tailings with a dust suppressing composition.

2. A dust suppressing composition comprising one or more suppressing reagents.

3. The dust suppressing composition of embodiment 2, wherein said suppressing reagents are selected from the group consisting of CMC, SiO₂ (silica), water glass, water, and a Pechini reagent.

4. The dust suppressing composition of embodiment 3, said composition comprising CMC and water, and optionally a Pechini reagent.

5. The dust suppressing composition of embodiment 3, said composition comprising CMC, SiO₂ (silica), water, and optionally a Pechini reagent, wherein said CMC and said silica are in a ratio of about 1:10.

6. The dust suppressing composition of embodiment 2, said composition comprising CMC, waterglass, water, and optionally a Pechini reagent, wherein CMC and waterglass are in a ratio of about 1:10.

7. The dust suppressing composition of embodiment 4, wherein said Pechini reagent comprises an aqueous solution of oxides mixed with an alpha-hydroxycarboxylic acid, such as citric acid.

8 The method of claim 1, wherein said composition is applied to the tailings as a liquid stream as it leaves a mine.

9. The dust suppressing composition of embodiment 3, said composition comprising CMC and water, wherein said composition has a viscosity below 100 cps at shear rates up to 1,000 s−1.

10. The dust suppressing composition of embodiment 3, said composition comprising 10-30 wt % CMC, water and silica or water glass.

11. A method of preparing a dust suppressing composition comprising
adding CMC and water, and optionally an inorganic reagent (such as silicate or silica), to a vessel to obtain a mixture;
stirring said mixture (using e.g., a shearing blade stirrer) for a period of time (e.g. at least 8 hours (e.g., overnight)) to obtain a CMC solution.
wherein said method involves optionally applying heat (e.g., to aid dissolution of CMC).

12. The method of embodiment 10, wherein said mixture is stirred for at least 5 days.

13. The method of embodiment 10, wherein said mixture is heated to at least 90 deg C.

14. The method of embodiment 10, wherein said mixture is stirred overnight and is heated to at least 90 deg. C.

15. The method of embodiment 10, where the Pechini reagent is first mixed with carboxy methyl cellulose (CMC).

16. The method of embodiment 1, wherein the composition is contacted with said tailing by spraying said composition on tailings.

17. The method of embodiment 1, wherein the composition is contacted by spraying on fresh tailings.

18. The method of embodiment 1, wherein the composition is contacted by spraying on legacy tailings.

19. The method of preparing the dust suppressing composition of the preceding embodiments, wherein the mixture can be washed away with water, or other treatment (such as water soluble inorganic acid, e.g., phosphoric acid, or inorganic base, e.g., sodium hydroxide, or inorganic salts, e.g., sodium hydroxide).

20. The dust suppressing composition of any of the preceding embodiments, wherein said CMC is present in an amount of 0.1-30 wt %, 0.1-2 wt %, or 2-10 wt % or 10-20 wt %, or 20-30 wt % or 10-30 wt %.

21. A method of preparing a dust suppressing composition according to any of the preceding embodiments, wherein said CMC solution obtained is in an amount of 0.1-30 wt %, 0.1-2 wt %, or 2-10 wt % or 10-20 wt %, or 20-30 wt % or 10-30 wt %.

22. A composition according to any of the preceding embodiments, wherein the composition can be washed away with water or other treatment.

23. The method of embodiment 1, wherein said composition is sprayed on said tailings.

24 The method of embodiment 1, wherein said dust suppression composition is mixed directly with a slurry comprising mine tailings (e.g., at the mill, and e.g., before being discharged to storage such as, at a tailings storage facility).

25. A composition according to any of the preceding embodiments, wherein said composition is sprayable.

26. A composition according to any of the preceding embodiments, wherein the composition is biodegradable.

27. A method of preparing a dust suppressing composition according to any of the preceding embodiments, wherein said tailing does not wash away or dissolve after application of said dust suppressing composition.

### EXAMPLES

The following examples are provided solely to illustrate the present invention and are not intended to limit the scope of the invention, described herein.

### Example 1. CMC and Pechini Solution

The following general steps can be used to prepare a dust suppression composition comprising a mixture of CMC with an additive. This example uses where Pechini reagent is included:
a) About 0.1 wt. % of carboxy methyl cellulose (CMC) is added to water and stirred at room temperature overnight.
b) the Pechini reagent is prepared (e.g., a polyester polymer is made by heating ethylene glycol to 60° C., then citric acid is added with constant stirring until a homogenous mixture is obtained.

The Pechini reagent is added to the 0.1 wt. % aqueous solution of CMC with stirring at room temperature.

The mixing process can take a long time to thoroughly mix the solution and the mixing time can take from one day to seven days to completely form a solution but the preferable duration of the mixing process is five days. The application of heat decreases the time for the mixture to form a solution.

The process makes a clear colorless water solution with a consistency similar to milk that can then be sprayed on to the tailing to suppress dust. Once applied the solution dries attaching itself to the dust and tailings and it immobilizes the dust. The concentration of CMC and Pechini reagent in the solution can range from 1% wt % to 20% wt % of the final solution if a thicker liquid is desired. The mixture is robust and can be handled using common chemical handling procedures and the mixture can be stored for over a year without decomposing. To promote spraying the viscosity of a solution should be below 100 cps at shear rates up to 1,000 s−1.

The mixture provides a number of advantages, including:
a) Minimal effect on copper ion in water or water being held by the polymer in dust aggregates.
b) The tailing pile will not dissolve or washed away by the mixture.
c) The CMC and Pechini polymers are organic matter, and environmentally benign. The mixture is biodegradable and will slowly break down over time in the ambient environment after the tailing has been removed.

### Example 2. CMC, Pechini and Silica Solution

One aspect of the invention includes the incorporation of an inorganic reagent in the dust suppression compositions disclosed herein. This can be used either alone or as an additive to CMC and/or the Pechini reagent. The inorganic reagents that may be used include silica and silicate, as well as other analogous metal oxides. Silica (SiO₂) in water (e.g., a silica hydrosol, e.g., HYDROSOL a nano silica aqueous dispersion from BASF and is also available from other vendors). Silicate (SiO₃⁻²) is a water-soluble form of silica called water glass. The inorganic silica reagents can also be mixed with CMC and/or with the Pechini reagent as described in Example 1. In some embodiments, the CMC portion of the mixture is approximately 2 wt % of the silica concentration which can be as high as 20 wt % of the final solution. Therefore, if the concentration of silica is 20% then the CMC concentration is 0.4%) with the Pechini reagent being about the same proportion as the silica.

The mixing process can take a long time to thoroughly mix the solution and the mixing time can take from one day to seven days to completely form a solution but the preferable duration of the mixing process is five days. The application of heat decreases the time for the mixture to form a solution.

When used as a spray, the final spray formulation is preferably about 2% silica, and Pechini reagent and 0.04% CMC.

When applied to the tailings using a spraying technique the solution dries and forms a film on the tailings. When analyzed the film is approximately ¼ micron thick and forms a film with low gas permeability. The precursor water solution is stable with a shelf life of over a year. The mixing procedure is important to avoid precipitation of components from the mixture.

Typical means of mixing include tank mixers, mechanical mixers, ultrasonic mixing and drum mixers, and the like.

Various solutions were made and include:
a) P2 which is 1.5% CMC;
b) A1, which is 40% Silica/1.5% CMC;
c) A2, which is 4% Silica/1.5% CMC;
d) A2′, which is 4% Silica;
e) B1, which is 40% Silicate/1.5% CMC;
f) B2, which is 4% Silicate/1.5% CMC; and
g) B2′, which is 4% Silicate.

The results of the solution formation experiments were as follows:
a) P2: CMC is added to water so that the weight percent was 1.5 wt %. The mixture was stirred with a stir bar, after days of stirring the mixture did not dissolve. The next attempt was to add heat and stir. When the mixture was heated to 90 degrees C. and stirred overnight the CMC dissolved in water. This experiment was repeated and was successful up to a 20 wt % mixture.
b) A1: A stock mixture of 40% Silica/1.5% CMC was varied from 1.5%-35%. The Silica was dissolved into the mixture by being stirred with a stir bar for a day without heat.
c) A2: A stock solution of CMC was diluted to form a 1.5 wt % CMC mixture. Silica was added to the mixture to form a 4 wt % mixture. The mixture was stirred for a day without heat to dissolve the CMC. The resulting mixture was a 4% Silica/1.5% CMC solution.
d) A2′: A stock solution of CMC was dilute with water to form a 1.5 wt % CMC mixture; The mixture was stirred for 1 day without heat to form the solution.
e) P2: A 1.5% CMC mixture was formed from CMC and water. The CMC is added to the mixture so that the concentration by weight is 1.5 wt % CMC. The mixture is stirred until the CMC is dissolved and a solution is formed.
f) B1: A 40% by weight silicate solution was formed by adding silicate so that a 40 wt % to the stock 1.5 wt % CMC solution was formed. The mixture of Silicate, CMC and water was stirred for a day without heat and the Silicate dissolved and formed a 40% Silicate/1.5% CMC solution;
g) B2: The 40% silicate/1.5% CMC solution was diluted so that the silicate concentration is 10% and then CMC was added to raise the concentration to 1.5 wt %. A suitable electrolyte was added and the mixture stirred overnight without heat to form the solution.
h) B2′: The 40% silicate/1.5% CMC solution was diluted so that the silicate concentration is 10% and CMC was added to raise the concentration to 1.5 wt %. A suitable electrolyte was added and the mixture stirred overnight without heat to form the solution.

All publications mentioned herein are incorporated by reference to the extent they support the present invention.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above disclose any additional subject matter that is not within the scope of the claims below, the inventions are not dedicated to the public and the right to file one or more applications to claim such additional inventions is reserved.

We claim:

1. A method of suppressing dust from mine tailings, said method comprising contacting said tailings with a dust suppressing composition.

2. A dust suppressing composition comprising one or more suppressing reagents.

3. The dust suppressing composition of claim 2, wherein said suppressing reagents are selected from the group consisting of CMC, SiO₂ (silica), water glass, water, and a Pechini reagent.

4. The dust suppressing composition of claim 3, said composition comprising CMC and water, and optionally a Pechini reagent.

5. The dust suppressing composition of claim 3, said composition comprising CMC, SiO₂ (silica), water, and optionally a Pechini reagent, wherein CMC and silica are in a ratio of about 1:10.

6. The dust suppressing composition of claim 3, said composition comprising CMC, waterglass, water, and optionally a Pechini reagent, wherein CMC and waterglass are in a ratio of about 1:10.

7. The dust suppressing composition of claim 4, wherein said Pechini reagent comprises an aqueous solution of oxides mixed with an alpha-hydroxycarboxylic acid.

8. The method of claim 1, wherein said composition is applied to the tailings as a liquid stream as it leaves a mine.

9. The dust suppressing composition of claim 2, wherein said composition has a viscosity of said composition is below 100 cps at shear rates up to 1,000 s−1.

10. The dust suppressing composition of claim 3, said composition comprising 10-30 wt % CMC, water and silica or water glass.

11. A method of preparing a dust suppressing composition comprising
adding CMC and water, and optionally an inorganic reagent (such as silicate or silica), to a vessel to obtain a mixture;
stirring said mixture (using e.g., a shearing blade stirrer) for a period of time (e.g. at least 8 hours (e.g., overnight)) to obtain a CMC solution.
wherein said method involves optionally applying heat (e.g., to aid dissolution of CMC).

12. The method of claim 9, wherein said mixture is stirred for at least 5 days.

13. The method of claim 9, wherein said mixture is heated to at least 90 deg C.

14. The method of claim 9, wherein said mixture is stirred overnight and is heated to at least 90 deg C.

15. The method of claim 9 where the Pechini reagent is first mixed with carboxy methyl cellulose (CMC).

16. The method of claim 1, wherein the composition is contacted with said tailing by spraying said composition on tailings.

17. The method of claim 1, wherein the composition is contacted by spraying on fresh tailings.

18. The method of claim 1, wherein the composition is contacted by spraying on legacy tailings.

20. The method of claim 1, wherein said dust is sprayed onto said tailings.

21. The method of claim 1, wherein said dust suppression composition is mixed directly with the slurry (e.g., at the mill) before being discharged to storage (e.g. at a tailings storage facility).

22. The dust suppressing composition of claim 7, wherein the composition is biodegradable.

23. The composition of claim 3, wherein said CMC is present in an amount of 0.1-30 wt %, 0.1-2 wt %, or 2-10 wt %, or 10-20 wt %, or 20-30 wt % or 10-30 wt %.
